(19) United States
(12) Patent Application Publication
(10) Pub. No.: US 2026/0125539 A1
(43) Pub. Date: May 7, 2026

(54) EXTRUSION PROCESS AIDS FOR POLYOLEFINS

(71) Applicants: Veerag Mehta, Monroe Township, NJ (US); Vikas Mehta, Monroe Township, NJ (US)

(72) Inventors: Veerag Mehta, Monroe Township, NJ (US); Vikas Mehta, Monroe Township, NJ (US)

(21) Appl. No.: 18/937,115

(22) Filed: Nov. 5, 2024

(51) Int. Cl. C08K 13/02; C08J 3/20; C08K 3/22; C08K 3/32; C08K 5/00; C08K 5/09; C08K 5/20

(52) U.S. Cl. CPC C08K 13/02; C08J 3/201; C08K 5/09; C08J 2323/08; C08J 2323/30; C08J 2323/36; C08K 2003/2296; C08K 2003/329; C08K 5/005; C08K 5/20; C08K 2201/014

(57) ABSTRACT

Organic molecules with free acid groups and a molecular weight of greater than 140 g/mol used in combination with surfactants, are used as processing aids in the formation of extrudates and other molded materials. The compositions of this invention can be used as defined herein, or can be used with prior art processing aids, depending on the end use application. The novel materials and processes provide a useful alternative to the sole use of fluorine-based polymer processing aids.

### CROSS-REFERENCE TO RELATED APPLICATIONS

Not applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

Prior art fluoropolymer-based processing aids in polyolefin resins have been used for many decades. They are used in resins like polyethylene to eliminate melt fracture, lower die pressures, and reduce die lip buildup. For other polyolefins like polypropylene, fluoropolymer process aids are used in much lower volume due to the shear thinning behavior of the resin, and the fact that the polymer chain scission during degradation lowers the polymer melt viscosity, making it less susceptible to melt fracture. Still, fluoropolymer process aids can be effective in polypropylene for lowering extrusion pressure, increasing polymer throughput, and eliminating die drool or die lip build-up. For other olefins, like polybutene and other polymers, with ethylene as a comonomer, the use of fluoropolymer process aids is less mentioned in literature, however, are commonly used in commercial practice.

By utilizing a process aid in a polyolefin, it allows for the ease of processing of a polymer through a die during extrusion. This happens in one of two ways. If the process aid functions as an external process aid, it will go to the interface between the polymer and the die and provide lubrication. This lubrication lowers shear stress and allows for easier movement of the polymer through a die.

Another possible way process aids can ease the processing of a polymer through a die is as an internal process aid. An internal process aid will act between the polymer chains and allow the polymer chains to move more easily past one another. With internal process aids, they lower the apparent viscosity of the material which allows the material to act like it has a lower viscosity, thus allowing it to move more easily through a die.

With regard to polyolefins, the largest use of process aids is in polyethylene, specifically, linear low-density polyethylene (LLDPE) followed by high density polyethylene (HDPE). The reason for this is during the extrusion of LLDPE, surface defects commonly known as melt fractures or sharkskin may occur which is a result when the shear rate at the surface of the polyolefin polymer is sufficiently high that the surface of the polymer begins to fracture. The severity and type of melt fracture appearance is the result of molecular weight distribution of the polyethylene resin, the shear thinning profile of the specific resin, the extrusion process, the die gap, and the speed of processing.

Fluoropolymer process aids function very effectively as external process aids, as they will coat a die during extrusion. This coating serves to help reduce melt fracture; however, it also helps to reduce and, in many cases, prevent die lip buildup which is not something that can be done by an internal process aid.

Within the structure of fluoropolymers, there are localized acidic functionalities or materials that could degrade to an acid with higher temperature which allows it to coat and almost bond to a die surface due to the interaction of the metal and the acid. It is this interaction that gives the fluoropolymers their excellent performance as process aids. The performance of bonding is accomplished by the acidic nature of the material. However, the die lip protection is further supplemented by nature of the fluoropolymer material to behave like a surfactant, specifically an anionic surfactant. A surfactant is defined as a molecule that lowers the surface or interfacial tension between two materials, in this case, the die and the molten polymer stream.

As a general class of materials, fluoropolymers have been used to alleviate melt fracture due to their excellent performance. The reason fluoropolymers perform well is due to their properties starting with the molecular structure, specifically that it orients in a helical structure. This kind of molecular packing allows for a tightly packed structure that is still very open on the atomic level due to carbon fluorine bonds. This kind of packing leads to low friction and excellent physical properties which are exhibited as high durability when they coat a die in extrusion processing.

Despite fluoropolymers being a great chemistry for lubrication, over the last several years, many fluoropolymer chemistries have been grouped under the umbrella of Per and polyfluoroalkyl substances (PFAS) which has come into question and now have been widely labeled as “forever chemicals” due to the fact that they are widely present in the environment, accumulate in humans, and do not break down quickly.

As a general class of materials, surfactants play an important role in many processes such as cleaning, wetting, dispersing, emulsifying, foaming and anti-foaming. Surfactants are found in many products including paints, emulsions adhesives, inks, biocides, shampoos, toothpastes, firefighting foams, and detergents.

Surfactants are materials that lower the surface tension or interfacial tension between two materials. In the general sense, any material that affects the interfacial surface tension can be considered a surfactant, but in the practical sense, surfactants may act as wetting agents, emulsifiers, foaming agents, and dispersants. Surfactants are broken into four main classes: cationic that is, having a positive charge on the molecule, anionic, that is, having a negative charge on the molecule, non-ionic, that is, having neither a positive or negative charge on the molecule, and amphoteric, that is, having both a positive and negative charge on the molecule.

### BRIEF SUMMARY OF THE INVENTION

Thus, what is disclosed and claimed herein in one embodiment is a process for preparing a thermoplastic composition extrudate wherein the process comprises extruding a thermoplastic composition in a melt extrusion process wherein the thermoplastic composition comprises a combination of a polyolefin selected from the group comprising linear polyolefin, a branched polyolefin, a homopolymer of polyolefin, a copolymer polyolefin, a terpolymer polyolefin, and mixtures thereof, and from 0.01% to 4% based on the weight of the polyolefin of a blend of materials selected from both:
A) a group consisting of a linear carbon-based material, and a branched carbon-based material, or mixtures thereof, each having a molecular weight greater than 140 g/mol and each having an acid value of 0.1 mg/KOH or above with an acid functionality on a backbone thereof consisting of one or multiple functional acid groups selected from the group consisting of phosphoric acid, phosphoric acid derivatives, sulphonic acid, sulphonic acid derivatives, carboxylic acid, carboxylic acid derivatives, dicarboxylic acid, dicarboxylic acid derivatives, tricarboxylic acid, tricarboxylic acid derivatives, acrylic acid, acid modified acrylic acid derivatives, carbonic acid, carbonic acid derivatives, Benzoic acid, benzoic acid derivatives, and mixtures thereof, and
B) a surfactant having a molecular weight of greater than 175 g/mol and selected from the group consisting of cationic, anionic, non-ionic, amphoteric, and mixtures thereof, and more preferably anionic, amphoteric, non-ionic, and mixtures thereof, wherein the melt extrusion is carried out in the absence of fluorinated or siloxane additives.

In another embodiment, the process described can be carried out, including in addition to the described components, other fluorinated or siloxane additives.

Yet another embodiment of this invention is extruded or molded articles produced from the process claimed in claim 1.

Still another embodiment of this invention is a composition that is a thermoplastic composition comprising an extrudate derived from a combination of a polyolefin selected from the group comprising a linear polyolefin, a branched polyolefin, a homopolymer of polyolefin, a copolymer polyolefin, a terpolymer polyolefin, and mixtures thereof, and, from 0.01% to 4% based on the weight of the polyolefin of a blend of materials selected from both:
A) of a material selected from the group consisting of a linear carbon-based material, and a branched carbon-based material, or mixtures thereof, each having a molecular weight greater than 140 g/mol and each having an acid value between 0.1 and 500 mg/KOH with an acid functionality on a backbone thereof consisting of one or multiple functional acid groups selected from the group consisting of phosphoric acid, phosphoric acid derivatives, sulphonic acid, sulphonic acid derivatives, carboxylic acid, carboxylic acid derivatives, dicarboxylic acid, dicarboxylic acid derivatives, tricarboxylic acid, tricarboxylic acid derivatives, acrylic acid, acid modified acrylic acid derivatives, carbonic acid, carbonic acid derivatives, benzoic acid, benzoic acid derivatives, and, mixtures thereof.
B) a surfactant having a molecular weight of greater than 175 g/mol selected from the group consisting of cationic, anionic, non-ionic, amphoteric, and mixtures thereof, and more preferably anionic, amphoteric, non-ionic, and mixtures thereof.

Another embodiment of this invention is a process for preparing a thermoplastic composition extrudate, the process comprising extruding a thermoplastic composition in a melt extrusion process, the thermoplastic composition comprising a combination of a polyolefin selected from the group comprising a linear polyolefin, a branched polyolefin, a homopolymer of polyolefin, a copolymer polyolefin, a terpolymer polyolefin, and mixtures thereof, and from 0.01% to 4% based on the weight of the polyolefin of a blend of material selected from:
A) the group consisting of a linear carbon-based material, a branched carbon-based material, and mixtures thereof, each having a molecular weight greater than 140 g/mol and each having an acid value between of 0.1 mg/KOH or greater with an acid functionality on a backbone thereof consisting of one or multiple functional acid groups selected from the group consisting of phosphoric acid, phosphoric acid derivatives, sulphonic acid, sulphonic acid derivatives, carboxylic acid, carboxylic acid derivatives, dicarboxylic acid, dicarboxylic acid derivatives, tricarboxylic acid, tricarboxylic acid derivatives, acrylic acid, acid modified acrylic acid derivatives, carbonic acid, carbonic acid derivatives, benzoic acid, benzoic acid derivatives, and mixtures thereof;
B) a surfactant having a molecular weight of greater than 175 g/mol selected from the group consisting of cationic, anionic, non-ionic, amphoteric, and mixtures thereof, and more preferably anionic, amphoteric, non-ionic, and mixtures thereof.

Processing aids and lubricants with free acid groups and relatively high molecular weights of greater than 300 g/mol are not commonly used as polymer processing additives in polyolefins because of their lack of processing stability and compatibility when used as an additive for the purpose of reducing melt fracture, lowering die pressures, and reducing die drool/die lip buildup.

The present disclosure provides a useful alternative to the sole use of fluorine-based polymer processing aids.

### BRIEF DESCRIPTION OF THE SEVERAL VIEWS OF THE DRAWING(S)

FIG. 1 is a table consisting of results of testing at 200° C.

FIG. 2 is a table consisting of results of testing at 220° C.

FIG. 3 is a table consisting of results of testing at 240° C.

### DETAILED DESCRIPTION OF THE INVENTION

One embodiment of this invention is a process for preparing a thermoplastic composition extrudate, the process comprising extruding a thermoplastic composition in a melt extrusion process; the thermoplastic composition comprising: i) a polyolefin; ii) an additive at 0.01% to 4% (based on the weight the polyolefin) of at least one organic acid where the acidic functionality is derived from the following families: phosphoric, sulphonic, carboxylic, dicarboxylic, tricarboxylic, acrylic or carbonic acid and their respected derivative and mixtures thereof, wherein the additive has an average molecular weight, Mw of greater than 140 g/mol, preferably between 170 g/mol and 10,000 g/mol and most preferably between 250 g/mol and 1,000 g/mol and having an acid value preferably between 0.01 and 500 mg/KOH and most preferably between 10 and 350 mg/KOH; iii) 0.01% to 4% based on the weight the polyolefin of at least one surfactant having a molecular weight of greater than 175 g/mol, and selected from the group consisting of cationic, anionic, non-ionic, amphoteric, and mixtures thereof, and more preferably anionic, amphoteric, non-ionic, and mixtures thereof.

As with fluoropolymers, the structure of fluoropolymers provides polarity and localized acidic functionality. The localized acidic functionality allows it to coat and almost bond to a die surface due to the interaction of the metal and the acid forming something that mimics a salt. It is this interaction that gives the fluoropolymers their excellent performance as process aids as this bond is very strong even with high temperatures.

In a similar capacity, in this invention, organic acid not only provides polarity that is effective at helping to coat the die in extrusion, but also allows it to complex react with the metal in the die due to the acidity of the additive, and the metal from the die. This essentially creates a coating in situ while processing.

Acid functional lubricants perform very well due to their acidic and polar nature and their ability to navigate through the polymerizing resin and migrate to the surface to perform release and lubrication functions on metal surfaces and dies. This in turn allows for reduced die lip build up and die drool during processing.

The surfactants act synergistically with acid, by helping to lower the interfacial tension after the acid has bonded to the metal. This combination is greater than what the acid or a surfactant can do on its own.

This has been seen in other polymer systems such as thermosetting polymers processed by pultrusion, sheet molding, or bulk molding processes where, in a dynamic and fluid condition, process aids based on phosphoric, carboxylic acids and other organic acids are used because they are able to migrate to the die polymer interface during the process to provide lubrication and die protection so that higher throughputs can be achieved while also reducing or eliminating die lip buildup and/or help clean mold surfaces with excellent release properties.

The use of “extrudate”, “extrusion” herein includes any form of extruded plastics or polymers such as, for example, films, sheets, pellets, tubes, wires, pipes, or other articles produced via what is considered an extrusion process.

### EXAMPLES

Using a Ceast SR20 Capillary Rheometer made by Instron Corporation (Norwood, MA), polymer resins modified with different additives were compared. In this test additives were compounded at levels of 1500 ppm in Marlex HXM50100 High Density Polyethylene made by Chevron Phillips Chemical located in The Woodlands, Texas, with a density of 0.948 g/cc and a HLMI of 10 g/10 min when tested at 190 C and 21.6 kg, using a ZSK26 twin screw compounding line manufactured by Coperion Corporation (Sewell, NJ). This resin was chosen due to it having a very high viscosity and due to having some hexene comonomer.

The testing was conducted at 200° C., 220° C., and 240° C., at shear rates that varied from 50 sec-1 to 2000 sec-1. A 20:1 L/D was used for all testing. The additives tested were as follows:
1) Techlube X1009 (Manufactured by Technick Products, Inc., South Plainfield, NJ)—X1009—a branched fatty acid
2) TechLube X1018 (Manufactured by Technick Products, Inc., South Plainfield, NJ)—a polyphosphoric acid
3) TechLube X1027 (Manufactured by Technick Products, Inc., South Plainfield, NJ)—a blend of non-ionic surfactants
4) TechLube X1044 (Manufactured by Technick Products, Inc., South Plainfield, NJ)—a blend of anionic surfactants
5) TechLube X1067 (Manufactured by Technick Products, Inc., South Plainfield, NJ)—a blend of 30% TechLube X1009 and 70% TechLube X1027
6) TechLube X1078 (Manufactured by Technick Products, Inc., South Plainfield, NJ)—a blend of 40% TechLube X1018 and 60% TechLube X1044

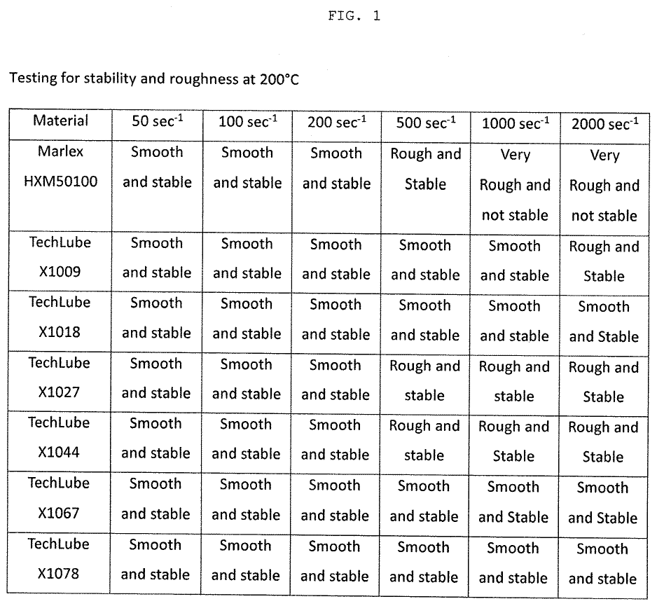

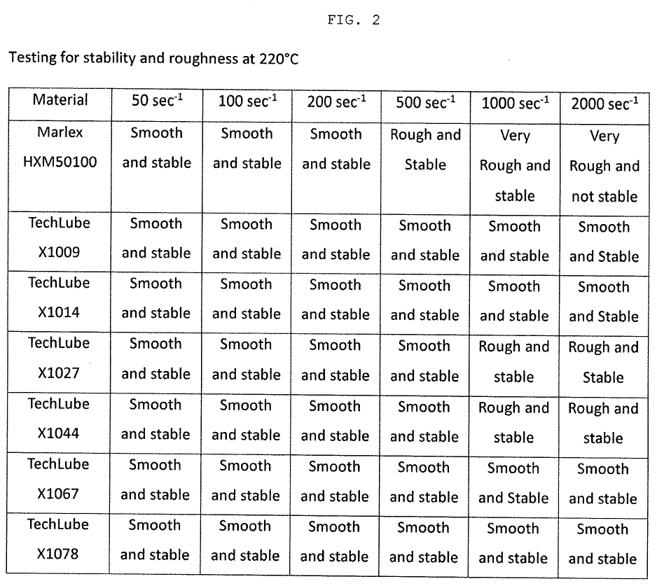

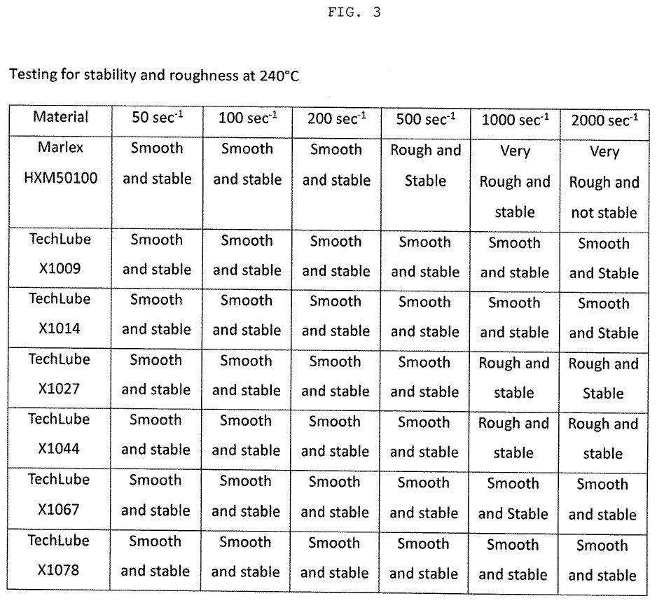

Using the capillary rheometer test, the pure Marlex HXM50100 and the additives blended into the Marlex HXM50100 were tested, and evaluated for stable flow and extrudate was evaluated for smooth surface feel at shear rates ranging from 50 sec-1 to 2000 sec-1. The results are summarized on the tables attached labeled as FIG. 1, FIG. 2, and FIG. 3.

Based on the testing, it can be seen the use of the different functional additives improved the flow stability and the surface appearance of the extrudate when compared to the pure Marlex HXM50100 and the use of the combination of the acid functional additives combined with the surfactant continually gave the best performance regardless of temperature. Though the temperature helped to improve the surface appearance, which is expected, still the benefits of using acid functional additives and surfactant together can be seen to greatly improve the shear rates over which a polymer could be processed.

What is claimed is:

1. A process for preparing a thermoplastic composition extrudate, the process comprising:
A) extruding a thermoplastic composition in a melt extrusion process, the thermoplastic composition comprising a polyolefin
selected from the group comprising:
a) a linear polyolefin,
b) a branched polyolefin,
c) a homopolymer of polyolefin,
d) a copolymer polyolefin,
e) a terpolymer polyolefin, and
f) mixtures of a)-e), and
from 0.01% to 4% based on the weight of the polyolefin of a material selected from the group consisting of a linear carbon-based material, a branched carbon-based material, and mixtures thereof, each having a molecular weight greater than 140 g/mol and each having an acid value of 0.1 mg/KOH or above with an acid functionality on a backbone thereof consisting of one or multiple functional acid groups selected from the group consisting of: i) phosphoric acid, (ii) phosphoric acid derivatives, (iii) sulphonic acid, iv) sulphonic acid derivatives, v) carboxylic acid, vi) carboxylic acid derivatives,
vii) dicarboxylic acid, viii)dicarboxylic acid derivatives, ix) tricarboxylic acid, x) tricarboxylic acid derivatives, xi) acrylic acid, xii) acid modified acrylic acid derivatives, xiii)carbonic acid, xiv) carbonic acid derivatives, xv) Benzoic acid, xvi) benzoic acid derivatives, and xvii) mixtures of i)-xvi), and
from 0.01% to 4% based on the weight of the polyolefin of at least one surfactant having a molecular weight of greater than 175 g/mol, and selected from the group consisting of cationic, anionic, non-ionic, amphoteric, and mixtures thereof;
B) wherein the melt extrusion is carried out in the absence of fluorinated or siloxane additives.

2. The process as claimed in claim 1 wherein the carbon-based material in the thermoplastic composition has an acid value of from 0.1 to 500 mg/KOH.

3. A process as claimed in claim 1 wherein the molecular weight of the carbon-based material is between 140g/mol and 10,000 g/mol.

4. A process as claimed in claim 1 wherein the molecular weight of the carbon-based material is between 250 g/mol and 1,000 g/mol.

5. A process as claimed in claim 1 wherein the molecular weight of the surfactant in the thermoplastic composition is between 300 and 10,000 g/mol.

6. The process as claimed in claim 1 wherein the polyolefin thermoplastic composition further comprises, in addition, process aids selected from the group consisting of:
i) polyethylene glycol,
ii) polyalkylene glycol, and
iii) metal carboxylic salts.

7. A thermoplastic composition comprising an extrudate derived from
A) a polyolefin selected from the group comprising:
a) a linear polyolefin,
b) a branched polyolefin,
c) a homopolymer of polyolefin,
d) a copolymer polyolefin,
e) a terpolymer polyolefin, and
f) mixtures of a)-e);
B) from 0.01% to 4% based on the weight of the polyolefin of a material selected from the group consisting of a linear carbon-based material, and a branched carbon-based material, and mixtures thereof, each having a molecular weight greater than 140 g/mol and each having an acid value between 0.01 and 500 mg/KOH with an acid functionality on a backbone thereof consisting of one or multiple functional acid groups selected from the group consisting of:
i) phosphoric acid, ii) phosphoric acid derivatives, iii) sulphonic acid,
iv) sulphonic acid derivatives, v) carboxylic acid, vi) carboxylic acid derivatives,
vii) dicarboxylic acid, viii) dicarboxylic acid derivatives, ix) tricarboxylic acid,
x) tricarboxylic acid derivatives, xi) acrylic acid, xii) acid modified acrylic acid derivatives, xiii) carbonic acid, xiv) carbonic acid derivatives, xv) benzoic acid, xvi) benzoic acid derivatives, and xvii) mixtures of i)-xvi);
from 0.01% to 4% based on the weight of the polyolefin of at least one surfactant having a molecular weight of greater than 175 g/mol, and selected from the group consisting of: cationic, anionic, non-ionic, amphoteric, and mixtures thereof.

8. A thermoplastic composition as claimed in claim 7 wherein, in addition, the carbon-based material is further modified with an oxide material selected from the group consisting of i) ethylene oxide and ii) propylene oxide.

9. A thermoplastic composition as claimed in claim 7 wherein the carbon-based material is further modified by a material selected from i) esters and ii) partial esters.

10. A thermoplastic composition as claimed in claim 7 wherein the carbon-based material is further modified by hydrogenation.

11. The thermoplastic composition as claimed in claim 7 wherein the carbon-based material is further modified with a compound selected from the group consisting of:
i) an amine and
ii) an amide.

12. The thermoplastic composition as claimed in claim 7 wherein the carbon-based material is further partially modified with reaction to make a metal salt.

13. The thermoplastic composition as claimed in claim 7 wherein the carbon-based material is reacted onto the polyolefin backbone.

14. The thermoplastic composition as claimed in claim 7 wherein a primary antioxidant is added thereto.

15. The thermoplastic composition as claimed in claim 7 wherein a secondary antioxidant is added thereto.

16. The thermoplastic composition as claimed in claim 7 wherein UV absorbers are added thereto.

17. The thermoplastic composition as claimed in claim 7 wherein light stabilizers are added thereto.

18. The thermoplastic composition as claimed in claim 7 wherein at least one metal deactivator is added therein.

19. The thermoplastic composition as claimed in claim 7 wherein zinc oxide is added thereto.

20. The thermoplastic composition as claimed in claim 7 wherein a slip aid selected from the group consisting of:
i) oleamide,
ii) Erucamide,
iii) Stearamide, and
iv) behenamide is added thereto.

21. The thermoplastic composition as claimed in claim 7 wherein
an anti-block material is added thereto

22. The thermoplastic composition as claimed in claim 7 wherein an acid scavenger material is added thereto.

23. The thermoplastic composition as claimed in claim 7 wherein a filler is added thereto selected from the group consisting of:
i) glass,
ii) calcium carbonate,
iii) diatomaceous earth,
iv) natural silica,
v) synthetic silica,
vi) silicates,
vii) asbestos,
viii) talc,
ix) mica,
x) kaolin,
xi) barium sulfate,
xii) metal oxides,
xiii) metal hydroxides,
xiv) graphite,
xv) carbon black, and
xvi) pigments.

23. The thermoplastic composition as claimed in claim 7 wherein additional additives can be added to the thermoplastic composition prior to extrusion, said additional additives selected from the group consisting of:
a) epoxidized vegetable oils,
b) epoxidized soybean oil,
c) lubricants,
d) emulsifiers,
e) Pigments,
f) optical brighteners,
g) feroxide scavengers,
h) flame retarding agents,
i) anti-static agents,
j) anti-fog agents,
k) blowing agents, and
l) thiosynergists selected from the group consisting of A) dilaurylthiodipropionate and B) distearylthiodipropionate.

24. A method for reducing melt extrusion defects during the extrusion of a thermoplastic composition comprising a polyolefin, the method comprising:
A. adding at least one acid functional additive to a polyolefin;
B. adding at least one surfactant to said polyolefin;
C. extruding the thermoplastic composition in a melt extrusion process; wherein the polyolefin is selected from the group consisting of low-density polyethylene, linear low density polyethylene, medium density polyethylene, very low density polyethylene, high density polyethylene, polypropylene, polybutene, ionomers, ethylene vinyl acetate copolymer, ethylene methyl acrylate copolymer, and mixtures thereof.

25. The method of claim 24, wherein the thermoplastic composition further comprises one or more process aids selected from the group consisting of:
i) polyethylene glycol,
ii) polyalkylene glycol,
iii) polysiloxanes,
iv) silicones,
v) metal carboxylic salts.

26. Extruded articles produced from the process claimed in claim 1.

27. Molded articles produced from the process claimed in claim 1.

28. A process for preparing a thermoplastic composition extrudate, the process comprising:
extruding a thermoplastic composition in a melt extrusion process, the thermoplastic composition comprising a combination of a polyolefin selected from the group comprising:
a. a linear polyolefin,
b. a branched polyolefin,
c. a homopolymer of polyolefin,
d. a copolymer polyolefin,
e. a terpolymer polyolefin, and
f. mixtures of a)-e);
from 0.01% to 4% based on the weight of the polyolefin of a material selected from the group consisting of a linear carbon-based material, and a branched carbon-based material, and mixtures thereof, each having a molecular weight greater than 140 g/mol and each having an acid value between of 0.1 mg/KOH or greater with an acid functionality on a backbone thereof consisting of one or multiple functional acid groups selected from the group consisting of:
i) phosphoric acid, ii) phosphoric acid derivatives, iii) sulphonic acid,
iv) sulphonic acid derivatives, v) carboxylic acid, vi) carboxylic acid derivatives,
vii) dicarboxylic acid, viii)dicarboxylic acid derivatives, ix) tricarboxylic acid,
x) tricarboxylic acid derivatives, xi) acrylic acid, xii) acid modified acrylic acid derivatives, xiii)carbonic acid, xiv) carbonic acid derivatives,
xv) Benzoic acid,
xvi) benzoic acid derivatives, and xvii) mixtures of i)-xvi). from 0.01% to 4% based on the weight of the polyolefin of at least one surfactant having a molecular weight greater than 175 g/mol, and selected from the group consisting of: cationic, anionic, non-ionic, amphoteric, and mixtures thereof.

29. The process as claimed in claim 27 wherein the thermoplastic composition has an acid value of from 0.1 to 500 mg/KOH.
